(19) United States
(12) Patent Application Publication
(10) Pub. No.: US 2020/0143269 A1
(43) Pub. Date: May 7, 2020

(54) Method and Apparatus for Determining a Travel Destination from User Generated Content

(71) Applicant: Bayerische Motoren Werke Aktiengesellschaft, Muenchen (DE)

(72) Inventors: Yang CAO, Chicago, IL (US); Alvin CHIN, Chicago, IL (US); Michael GORELIK, Lake Zurich, IL (US); James HU, Hoffman Estates, IL (US); Qing LI, Chicago, IL (US); Jilei TIAN, Chicago, IL (US)

(21) Appl. No.: 16/736,902

(22) Filed: Jan. 8, 2020

Related U.S. Application Data
(63) Continuation of application No. PCT/EP2017/078865, filed on Nov. 10, 2017.

(51) Int. Cl. G06N 5/04; G06N 20/00; G06Q 10/04; G06F 40/30; H04W 4/029

(52) U.S. Cl. CPC G06N 5/04; G06N 20/00; H04W 4/029; G06F 40/30; G06Q 10/047

(57) ABSTRACT

A method for determining a travel destination from user generated content is proposed. The method includes determining a text string in the user generated content that indicates a place or an address. Further, the method includes determining a plurality of potential travel destinations based on the text string. The method additionally includes determining similarities between the plurality of potential travel destinations and a plurality of reference positions assigned to the user, and ranking the plurality of potential travel destinations based on the similarities.

### CROSS REFERENCE TO RELATED APPLICATION

This application is a continuation of PCT International Application No. PCT/EP2017/078865, filed Nov. 10, 2017, the entire disclosure of which is herein expressly incorporated by reference.

### BACKGROUND AND SUMMARY OF THE INVENTION

The present disclosure relates to travel destination recognition. In particular, examples relate to a method as well as an apparatus for determining a travel destination from user generated content. Further examples relate to a vehicle.

In smart (vehicle) digital services, destination recognition and prediction plays an important role to improve the personal user experience. There are more and more destinations embedded in user generated contents (e.g., calendar, e-mail, social media, networks or even multimedia content). Some applications can intelligently parse some of the e-mail invitations from a meeting or itinerary, and generate the destination automatically. But there are many destinations where users enter incomplete addresses that are not recognized as locations. These places cannot be parsed (so called unparsable places) into geo-locations. For these unparsable places, conventional applications output candidate lists with a high number of false positive entries due to over-recognition. At the same time, false negative entries are missing in the list due to under-recognition.

Hence, there may be a demand for improved travel destination recognition.

The demand may be satisfied by examples described herein.

A first example relates to method for determining a travel destination from user generated content. The method comprises determining a text string in the user generated content that indicates a place or an address. Further, the method comprises determining a plurality of potential travel destinations based on the text string. The method additionally comprises determining similarities between the plurality of potential travel destinations and a plurality of reference positions assigned to the user, and ranking the plurality of potential travel destinations based on the similarities.

A second example relates to a non-transitory machine readable medium having stored thereon a program having a program code for performing the method as described herein, when the program is executed on a processor.

A third example relates to an apparatus for determining a travel destination from user generated content. The apparatus comprises an interface configured to receive the user generated content. Additionally, the apparatus comprises a processor circuit configured to determine a text string in the user generated content that indicates a place or an address, and to determine a plurality of potential travel destinations based on the text string. Further, the processor circuit is configured to determine similarities between the plurality of potential travel destinations and a plurality of reference positions assigned to the user, and to rank the plurality of potential travel destinations based on the similarities.

A fourth example relates to a vehicle. The vehicle comprises an interface configured to receive user generated content, and a memory configured to store a plurality of reference positions assigned to the user. Additionally, the vehicle comprises a processor circuit configured to determine a text string in the user generated content that indicates a place or an address, and to determine a plurality of potential travel destinations based on the text string. The processor circuit is further configured to determine similarities between the plurality of potential travel destinations and the plurality of reference positions, and to rank the plurality of potential travel destinations based on the similarities.

By using the plurality of reference positions assigned to the user (i.e., a user profile), examples of the present disclosure may allow to reduce over-recognition (i.e., false positives) and under-recognition (i.e., false negatives) since the user profile allows to recognize potential travel destinations based on the knowledge about the user's behavior in the past.

Some examples of apparatuses and/or methods will be described in the following by way of example only, and with reference to the accompanying figures.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a flowchart of an example of a method for determining a travel destination from user generated content.

FIG. 2 illustrates a flowchart of another example of a method for determining a travel destination from user generated content.

FIG. 3 illustrates an example of an apparatus for determining a travel destination from user generated content.

FIG. 4 illustrates an example of a vehicle.

### DETAILED DESCRIPTION OF THE DRAWINGS

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure Like numbers refer to like or similar elements throughout the description of the figures, which may be implemented identically or in modified form when compared to one another while providing for the same or a similar functionality.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

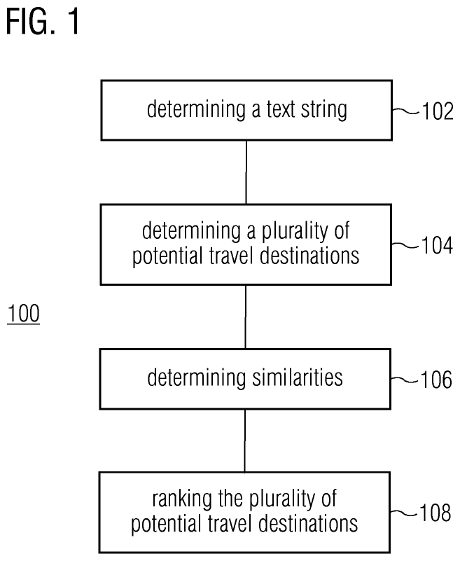

FIG. 1 illustrates a method 100 for determining a travel destination from user generated content. User generated content is any content generated by a user (e.g., textual content that is based on the user generated content). For example, user generated content may be one or more characters or words input by a user via a keyboard, a touch display, a mouse, or any other suitable human-machine-interface. User generated content may further be content recognized into textual format (e.g., through speech recognition on user's speech), or textual information extracted from image and video (e.g., by Optical Character Recognition, OCR, etc.).

Method 100 comprises determining 102 a text string in the user generated content that indicates a place or an address. Using natural language processing or other techniques allows to segment and extract places and/or addresses from user generated contents (e.g., calendar, e-mail, chat or messaging applications). Places and/or addresses may further be extracted from structured data like, e.g., a calendar location field.

Further, method 100 comprises determining 104 a plurality of potential travel destinations based on the text string. For example, geocoding applications may be used to determine one or more potential travel destinations (and its associated geographical positions) from a text string indicating an address (or at least part thereof). Point-Of-Interest (POI) search applications may be used to determine one or more potential travel destinations (and its associated geographical positions) from a text string indicating a place.

Method 100 additionally comprises determining 106 similarities between the plurality of potential travel destinations and a plurality of reference positions assigned to the user. The plurality of reference positions assigned to the user may be understood as a user profile. For example, the reference positions may be gathered using machine learning algorithms from user data (big data). In other words, the plurality of reference positions may characterize a user behavior. For example, the plurality of reference positions assigned to the user may comprise at least one of a frequent travel destination of the user, a recent travel destination of the user, a current location of the user, a travel destination searched by the user, a travel destination determined previously from user generated content, a preferred travel destination of the user and a recommended travel destination for the user.

The similarity between one of the plurality of potential travel destinations and one of the plurality of reference positions may be determined based on one or more criteria. For example, distances between a geographic position of the potential travel destination and a geographic position of the reference position may be one criterion for the similarity. Alternatively or additionally, further criteria like similarity of the addresses of the potential travel destination and the reference position, semantic similarity of the potential travel destination and the reference position, similarity of scores (confidence levels, qualities) of the potential travel destination and the reference position, etc. may be used. If more than one criterion is used for determining the similarity between the potential travel destination and the reference position, a dedicated metric may be used for weighting the individual criteria.

Method 100 further comprises ranking 108 the plurality of potential travel destinations based on the similarities. Ranking 108 the plurality of potential travel destinations based on the similarities exploits the knowledge about the user's behavior in the past. The more similar a potential travel destination is to one of the reference positions, the more likely it is that a user wants to travel to the potential travel destination. On the contrary, the more dissimilar a potential travel destination is to one of the reference positions, the more unlikely it is that a user wants to travel to the potential travel destination. Accordingly, by ranking the plurality of potential travel destinations based on the similarities, more likely travel destinations of the plurality of potential travel destinations may be listed. Accordingly, over-recognition (i.e. false positives) and under-recognition (i.e. false negatives) may be reduced.

Ranking 108 the plurality of potential travel destinations may, e.g., comprise determining, for each of the plurality of potential travel destinations, a maximum similarity between the respective potential travel destination and the plurality of reference positions. Additionally, ranking 108 the plurality of potential travel destinations may comprise selecting a subset of the plurality of potential travel destinations having a maximum similarity that is above a first threshold value, and ranking only the subset of the plurality of potential travel destinations based on the maximum similarity. Accordingly, only those potential travel destinations of the plurality of potential travel destinations may be ranked that have a predetermined likelihood. Accordingly, over-recognition (i.e. false positives) and under-recognition (i.e. false negatives) of potential travel destinations may be reduced by using the user profile.

Method 100 may further comprise determining a quality indicator (confidence level, confusion level) based on the number of potential travel destinations in the subset of the plurality of potential travel destinations. If the subset of the plurality of potential travel destinations comprises more potential travel destinations, the likelihood that one of the potential travel destinations of the subset is the correct travel destination (i.e., the travel destination indicated by the text string of the user generated content) is lower. On the other hand, if the subset of the plurality of potential travel destinations comprises less potential travel destinations, the likelihood that one of the potential travel destinations of the subset is the correct travel destination is higher. Therefore, the quality indicator indicates if the confidence level for the subset of the plurality of potential travel destinations is high or low, i.e. if there's low or high confusion.

The quality indicator may be used by other methods/applications/programs for deciding about whether or not to use the potential travel destinations in the subset of the plurality of potential travel destinations. For example, if the quality indicator indicates a high quality (i.e., high confidence level, low confusion) of the potential travel destinations in the subset of the plurality of potential travel destinations, an application/program may use one or more of the potential travel destinations in the subset of the plurality of potential travel destinations. On the contrary, if the quality indicator indicates a low quality, the application/program may neglect the potential travel destinations in the subset of the plurality of potential travel destinations.

In order to make this information accessible, method 100 may optionally further comprise storing the subset of the plurality of potential travel destinations together with the quality indicator in a memory that is accessible by software applications.

If the subset of the plurality of potential travel destinations comprises zero potential travel destinations, i.e., if the similarity between the plurality of potential travel destinations and the plurality of reference positions is rather low, method 100 may further comprise determining a second subset of the plurality of potential travel destinations whose geographical positions have a distance to a current location of the user that is smaller than a second threshold value. Further, method 100 may comprise determining a second quality indicator based on the number of potential travel destinations in the second subset of the plurality of potential travel destinations. If the second quality indicator fulfills a quality criterion, method 100 may further comprise presenting the second subset of the plurality of potential travel destinations to the user. Method 100 may, hence, take into account that users conventionally travel within a limited area. By restricting the potential travel destinations in the second subset of the plurality of potential travel destinations to those in a relative proximity of the user, potential travel destinations with increased likelihood may still be presented to the user. Accordingly, the user may verify the correctness of one of the potential travel destinations in the second subset of the plurality of potential travel destinations by a user input.

In some examples, the above quality criterion may further depend on a category of the plurality of potential travel destinations. Accordingly, the presentation of the potential travel destinations may be context dependent. For example, if the plurality of potential travel destinations relate to airports, train stations or other public transport facilities, a first quality indicator may be used, whereas a second quality indicator may be used, if the potential travel destinations relate to a different category (e.g., shopping, medical service, entertainment etc.).

Method 100 may further comprise filtering the plurality of potential travel destinations using at least one of a blacklist of travel destinations and a white list of travel destinations. The blacklist of travel destinations lists travel destinations which are to be rejected (avoided). The whitelist of travel destinations lists travel destinations which are always to be considered as potential travel destinations. For example, the travel destinations in the blacklist of travel destinations and/or the travel destinations in the white list of travel destinations may be based on a user input. Accordingly, user preferences may be learned and used for recognizing travel destinations from the user generated content. Accordingly, a precision of the travel destination recognition may be increased.

As indicated above, method 100 may comprise presenting, to the user, one or more top-ranked potential travel destinations of the plurality of potential travel destinations. Further, method 100 may comprise receiving a user input indicating a correctness of at least one of the one or more top-ranked potential travel destinations. Accordingly, method 100 may allow the user to verify the correctness of one or more recognized travel destinations. The user input indicating the correctness of at least one of the one or more top-ranked potential travel destinations may, e.g., be used for creating/updating the blacklist and/or the whitelist of travel destinations. For example, if the user input indicates that one of the one or more top-ranked potential travel destinations is correct, the travel destination may be put on the whitelist. If the user input indicates that one of the one or more top-ranked potential travel destinations is incorrect, the travel destination may be put on the blacklist.

If the user input indicates one of the one or more top-ranked potential travel destinations as correct, the method may further comprise storing the one of the one or more top-ranked potential travel destinations as the travel destination of the user.

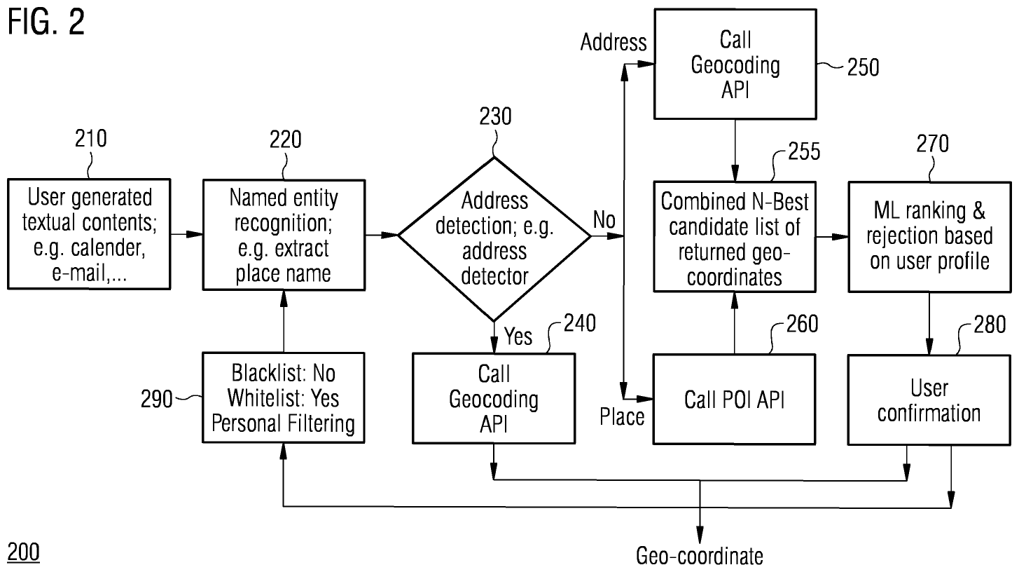

As described above, determining the similarity between the plurality of potential travel destinations and the plurality of reference positions may comprise determining distances between geographic positions of the plurality of potential travel destinations and geographic positions of the plurality of reference positions assigned to the user. Accordingly, ranking the plurality of potential travel destinations based on the similarities comprises ranking the plurality of potential travel destinations may be based on the distances. An exemplary flowchart of a method 200 for determining a travel destination from user generated content, which uses the distances between the geographic positions of the plurality of potential travel destinations and geographic positions of the plurality of reference positions, is described in the following with reference to FIG. 2.

In component 210, user generated content is received. As indicated in FIG. 2, the user generated content may originate from many different sources like a calendar, e-mail, etc.

Next, one or more text strings in the user generated content that indicate places or addresses are determined in component 220. As described above, natural language processing may allow to segment and extract places and addresses from user generated contents. Further, places and addresses may be directly extracted from structured data (e.g., calendar location field).

In component 230, address detection is performed. That is, it is attempted to assign the text strings extracted from the user generated context to known addresses (i.e., address recognition is performed). For example, a library of known addresses may be used.

In component 240, a geocoding service may be used to determine the geo-coordinate (i.e. the geographical position) for a given address, if the text strings extracted from the user generated context can be assigned to a known address in component 230.

However, known addresses are usually given in a specific format which may vary from region to region, or from country to country. Moreover, many services for address recognition expect a certain format for the address that is to be checked. On the other hand, users often do not use full addresses or use formats different than those expected by the address recognition services. Accordingly, only a limited number of addresses detected in the user generated content (i.e., the determined text strings) are detected as valid addresses that can be mapped. Commonly, the majority (e.g., more than 70%) of detected addresses is not recognized as valid addresses.

Method 200, hence, comprises further components that enable to (greatly) improve the performance by smartly finding more locations from the majority of unmapped places due to leveraging the proposed concept using machine learning over personal data.

If the text string indicates an address, a geocoding service is used in component 250 to obtain a geo-coordinate from the given (full) address. If the text string indicates a place, a place POI search service is used in step 260 to obtain a geo-coordinate from a place name. The results of the geocoding and the POI search are combined in component 255, so that plurality of potential travel destinations is effectively determined by method 200.

In component 270, a machine learning algorithm over big data is used to build a user's profile and behavior that helps to improve both false positives and false negatives by rejection and ranking. In component 270, a machine learning (ML) system is trained for location detection by collecting and evaluating addresses for existing users. This may allow improvement in location detection accuracy by combining conventional sources for the location detection such as re-gex based address parsing and geolocation services with a self-learning system based on the user behavior.

For the user profile, the system learns the user's destinations. The user's destinations may include frequent destinations, recent destinations, a current location, searched destinations, learned calendar destinations, preferred and/or recommended destinations of the user. Accordingly, a plurality of reference positions assigned to the user may be provided.

Each potential travel destination “des” may be represented by a set of parameters, such as:

des=(latitude, longitude, full address, place name, score, destination type, miscellaneous) where “score” denotes a confidence level or a quality of the set of parameters. The score may, e.g., be based on the source of a parameter. For example, if a parameter is obtained from a trustworthy provider (e.g., renowned geocoding service), the score may be high, whereas the score may be low, if the parameter is obtained from a new, unknown or other provider (e.g., a social network).

Accordingly, the user profile may be understood as a quantity of potential travel destinations:

Profile={desᵢ,des₂ . . . ,desₙ}

For each potential travel destination (also named candidate) in the destination candidate list, its geocoded location may be obtained by calling geocoding or POI search services (via a corresponding Application Programming Interface, API). For each potential travel destination, its distance against the user profile may then be measured. That is, in component 270 the distances between geographic positions of the plurality of potential travel destinations and geographic positions of the plurality of reference positions assigned to the user are determined. As described above, other criteria may be used alternatively or additionally to the distance of the geographic positions in order to determine the similarity of the potential travel destinations and the plurality of reference positions.

This may be summarized as follows:

D(candidate)=Min{d(candidate,des₁),d(candidate,des₂), . . . ,d(candidate,desₙ)}

where “d” is defined as distance between two locations. “d” may optionally be enhanced by combining the distance with other parameters like address, name or score similarity.

Subsequently, candidate filtering may be done. For example, all candidates may be removed for which D exceeds a threshold (e.g., 100, 200, 500, 1000, 2000 or 5000 meters), as it doesn't match well with user profile. In other words, a subset of the plurality of potential travel destinations having a maximum similarity that is above a threshold value is selected.

For each place, the confusion C is calculated. That is, a quality indicator is determined based on the number of potential travel destinations in the subset of the plurality of potential travel destinations. For example, more results may lead to a higher confusion:

C(place)=count{candidate|place)

Subsequently, only a subset of the plurality of potential travel destinations is ranked based on the maximum similarity. For example, only those candidates may be output in component 280 which have a distance D (candidate)<500 meters, wherein the candidates are ranked based on the distance D. Here, it is assumed that the user's destination location (i.e., the candidate) matches his profile (e.g., visited place, interested place or socially cited place, etc.)

If a user confirms the correctness of an output candidate (i.e., one of the potential travel destinations) in component 280, the candidate may be added to a whitelist. If the user negates the correctness, the candidate may be added to a blacklist. As indicated by component 290, the blacklist and the whitelist may be used as filtering factor.

If no result is found for the above distance threshold, a different approach may be used. In this approach, it is assumed that a user deals with a local area that is feasible and likely to drive for a given context. For example, the user will very likely not set the driving destination to the airport in LA while the user stays in Chicago. After the user arrives in LA, the system may adapt and update the destination accordingly. In addition, it the confusion is too high, system can reject the output.

For example, the following candidates may be output to the user if no result is found for the above distance threshold:

a) d(candidate, current location)≤200 miles AND C(place)≤5, if category is airport, train station, . . . ; or
b) d(candidate, current location)≤200 miles AND C (place)≤2, if other categories.

As described above, a location that has high confusion may be rejected depending on the category.

It is to be noted that the above numerical values are merely for illustration, and not limiting. Any other suitable values may be used instead.

The proposed concept may allow improvement in intelligent and personal user experience: The destinations are automatically recognized from user generated contents, so improved experience from machine learning over rich data source (e.g., calendar, email, social media and networking) as well as profiling from user's driving data is provided.

Moreover, the proposed concept may enable improved relevancy and accuracy by machine learning: The concept provides modelling user profiles and ranking the most relevant geo-coordinate automatically from user generated contents. The framework takes the relevancy and confusion into account in order to minimize user's interaction.

The proposed concept may be understood as a novel hybrid approach: It provides an approach for destination recognition with user profile and behavior learning over user's big personal and context data. It also applies to address and place entities, i.e., combining geocoding and search service, to make the destination recognition broader.

Moreover, the proposed concept may enable high performance with limited user interaction: User may be not asked to take any action when the confidence is high (i.e., the confusion is low). If necessary, the user just needs to confirm the results that are ranked by highly relevant info with low cognitive load, thus improving user interaction as well as the accuracy confirmed by users.

Further, the proposed concept may enable driving of consumer and business values: By knowing the user's next trips automatically, systems may, e.g., plan user's trip, monitor dynamic change of information and notify user (e.g., real time traffic information update, weather and refuel service, alternative route suggestion, time to leave notification, event timely update for schedule of airline, train, concert, social meeting), or have the navigation setting automatically. In general, it opens the opportunity for more innovation around the enabling technique with potential consumer and business values.

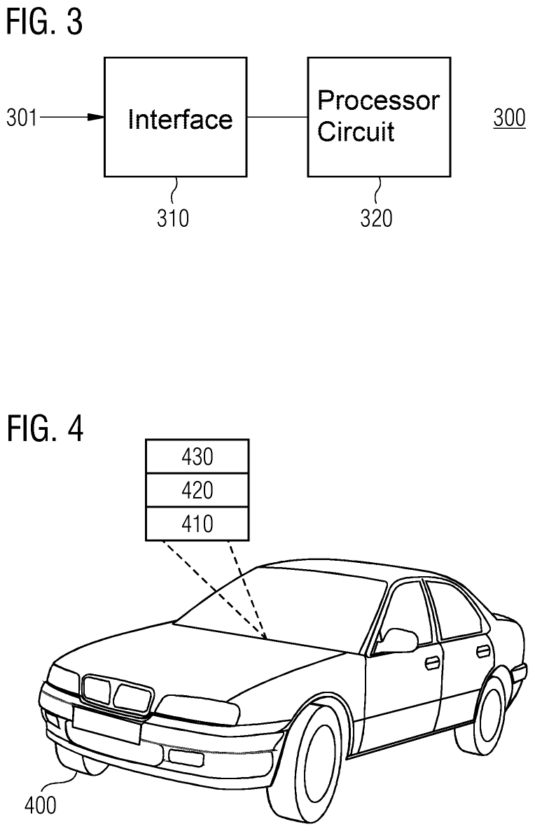

FIG. 3 further illustrates an apparatus 300 for determining a travel destination from user generated content. Apparatus 300 comprises an interface 310 configured to receive the user generated content 301. Additionally, apparatus 300 comprises a processor circuit 320 configured to determine a text string in the user generated content 301 that indicates a place or an address, and to determine a plurality of potential travel destinations based on the text string. Further, the processor circuit 320 is configured to determine similarities between the plurality of potential travel destinations and a plurality of reference positions assigned to the user, and to rank the plurality of potential travel destinations based on the similarities.

Apparatus 300 may allow reducing over-recognition and under-recognition by using the plurality of reference positions assigned to the user (i.e., the user profile). Accordingly, apparatus 300 may allow recognition of potential travel destinations of the user with increased accuracy.

For example, apparatus 300 may provide the ranked plurality of potential travel destinations to a navigation system. The navigation system may use the information to offer automatic navigation or pro-actively inform/engage the user (real time traffic information, weather up-date, time to leave notification) and, hence, increase a user experience.

More details and aspects of apparatus 300 are mentioned in connection with the proposed concept or one or more examples described above (e.g., FIGS. 1 and 2). The apparatus 300 or one of its elements (e.g., processor circuit 320) may comprise or be configured to perform one or more additional optional features corresponding to one or more aspects of the proposed concept or one or more examples described above.

An example of an implementation using a method according to one or more aspects of the proposed concept or one or more examples described above is illustrated in FIG. 4.

FIG. 4 illustrates a vehicle 400. The vehicle 400 is illustrated as an automobile. However, the vehicle 400 may be any apparatus that comprises an engine and wheels (and optionally a powertrain system). For example, the vehicle 400 may be a private vehicle or a commercial vehicle. In particular, the vehicle 400 may be an automobile, a truck, a motorcycle, or a tractor.

Vehicle 400 comprises an interface 410 configured to receive user generated content, and a memory 420 configured to store a plurality of reference positions assigned to the user. Additionally, vehicle 400 comprises a processor circuit 430 configured to determine a text string in the user generated content that indicates a place or an address, and to determine a plurality of potential travel destinations based on the text string. Processor circuit 430 is further configured to determine similarities between the plurality of potential travel destinations and the plurality of reference positions, and to rank the plurality of potential travel destinations based on the similarities.

Vehicle 400 may allow a reduction in over-recognition and under-recognition of potential travel destinations by using the plurality of reference positions assigned to the user (i.e., the user profile). Accordingly, vehicle 400 may allow recognition of potential travel destinations of the user with increased accuracy.

As described above, many different criteria may be used for determining the similarities between the plurality of potential travel destinations and the plurality of reference positions. For example, the distances between geographical positions of the plurality of potential travel destinations and geographical positions of the plurality of reference positions may be used. Alternatively or additionally, further criteria like similarity of the addresses of the potential travel destinations and the reference positions, semantic similarity of the potential travel destinations and the reference positions, similarity of scores (confidence levels, qualities) of the potential travel destinations and the reference positions, etc. may be used.

As described above with more details, processor circuit 430 may rank the plurality of potential travel destinations by determining, for each of the plurality of potential travel destinations, a maximum similarity between the respective potential travel destination and the plurality of reference positions, selecting a subset of the plurality of potential travel destinations having a maximum similarity that is above a first threshold value, and ranking only the subset of the plurality of potential travel destinations based on the maximum similarity.

Further, processor circuit 430 may determine a quality indicator (confusion level) based on the number of potential travel destinations in the subset of the plurality of potential travel destinations.

The processor circuit 430 may store the subset of the plurality of potential travel destinations together with the quality indicator in a memory of the vehicle 400 that is accessible by software applications executed in the vehicle 400. Accordingly, other software applications executed in the vehicle 400 may be provided with the information about future travel destinations of the user together with information about the quality (confidence level) of the recognized travel destination. Based on the quality indicator, the other software applications executed in the vehicle 400 may decide about whether or not to use the recognized travel destination. For example, a navigation application executed in the vehicle 400 may decide about automatically planning a route to the recognized travel destination based on the quality indicator. If the quality indicator indicates a low confidence level of the recognized travel destination, the navigation application may, e.g., decide to not automatically plan a route to the recognized travel destination. On the other hand, if the quality indicator indicates a high confidence level of the recognized travel destination, the navigation application may decide to automatically plan a route to the recognized travel destination.

The vehicle 400 may further allow gathering user input related to the recognized travel destination. For example, the vehicle 400 may further comprise a display (not illustrated) for presenting, to the user, one or more top-ranked potential travel destinations of the plurality of potential travel destinations. Additionally, the vehicle 400 may comprise an input device (not illustrated) configured to receive a user input indicating a correctness of at least one of the one or more top-ranked potential travel destinations. Accordingly, the user may verify the correctness of one or more recognized travel destinations. The display and the input device may be implemented as separate devices or as a single device (e.g., as touch display).

If the user input indicates one of the one or more top-ranked potential travel destinations as correct, the processor circuit 430 may further store the one of the one or more top-ranked potential travel destinations as travel destination of the user in a memory of the vehicle 420. By storing the user-verified travel destination in the memory, processor circuit 420 may provide information about a future travel destination of the user to other software applications executed in the vehicle 400. These software applications may use this information to provide intelligent services and assistance to the user (e.g., background route determination, real time traffic information, time to leave notification). Accordingly, user experience may be improved. Since the travel destination is user-verified, the quality indicator (confidence level) for the stored travel destination may be high (e.g., highest).

More details and aspects of vehicle 400 are mentioned in connection with the proposed concept or one or more examples described above (e.g., FIGS. 1 and 2). Vehicle 400 or one of its elements (e.g., processor circuit 430) may comprise or be configured to perform one or more additional optional features corresponding to one or more aspects of the proposed concept or one or more examples described above.

The aspects and features mentioned and described together with one or more of the previously detailed examples and figures, may as well be combined with one or more of the other exam-pies in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as non-transitory digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

When provided by a processor, the functions may be provided by a single dedicated processor, by a single shared processor, or by a plurality of individual processors, some of which or all of which may be shared. However, the term “processor” is by far not limited to hardware exclusively capable of executing software, but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in a non-transitory machine readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for determining a travel destination from user generated content, the method comprising:
determining a text string in the user generated content that indicates a place or an address;
determining a plurality of potential travel destinations based on the text string;
determining similarities between the plurality of potential travel destinations and a plurality of reference positions assigned to the user; and
ranking the plurality of potential travel destinations based on the similarities.

2. The method of claim 1, further comprising:
presenting, to the user, one or more top-ranked potential travel destinations of the plurality of potential travel destinations; and
receiving a user input indicating a correctness of at least one of the one or more top-ranked potential travel destinations.

3. The method of claim 2, further comprising:
when the user input indicates one of the one or more top-ranked potential travel destinations as correct, storing the one of the one or more top-ranked potential travel destinations as the travel destination of the user.

4. The method of claim 1, wherein the reference positions assigned to the user comprise at least one of a frequent travel destination of the user, a recent travel destination of the user, a current location of the user, a travel destination searched by the user, a travel destination determined previously from user generated content, a preferred travel destination of the user and a recommended travel destination for the user.

5. The method of claim 1, wherein ranking the plurality of potential travel destinations comprises:
determining, for each of the plurality of potential travel destinations, a maximum similarity between the respective potential travel destination and the plurality of reference positions; and
selecting a subset of the plurality of potential travel destinations having a maximum similarity that is above a first threshold value; and
ranking only the subset of the plurality of potential travel destinations based on the maximum similarity.

6. The method of claim 5, further comprising:
determining a quality indicator based on the number of potential travel destinations in the subset of the plurality of potential travel destinations.

7. The method of claim 6, further comprising:
storing the subset of the plurality of potential travel destinations together with the quality indicator in a memory that is accessible by software applications.

8. The method of claim 5, wherein, when the subset of the plurality of potential travel destinations comprises zero potential travel destinations, the method further comprises:
determining a second subset of the plurality of potential travel destinations whose geographical positions have a distance to a current location of the user that is smaller than a second threshold value;
determining a second quality indicator based on the number of potential travel destinations in the second subset of the plurality of potential travel destinations; and
presenting the second subset of the plurality of potential travel destinations to the user, when the second quality indicator fulfills a quality criterion.

9. The method of claim 8, wherein the quality criterion depends on a category of the plurality of potential travel destinations.

10. The method of claim 1, wherein determining the similarity between the plurality of potential travel destinations and the plurality of reference positions comprises determining distances between geographic positions of the plurality of potential travel destinations and geographic positions of the plurality of reference positions assigned to the user, and wherein ranking the plurality of potential travel destinations based on the similarities comprises ranking the plurality of potential travel destinations based on the distances.

11. The method of claim 1, further comprising:
filtering the plurality of potential travel destinations using at least one of a blacklist of travel destinations and a white list of travel destinations.

12. The method of claim 11, wherein the travel destinations in the blacklist of travel destinations and/or the travel destinations in the white list of travel destinations are based on a user input.

13. A non-transitory machine readable medium having stored thereon a program having a program code which when executed by a processor causes the processor to perform a method comprising:
determining a text string in the user generated content that indicates a place or an address;
determining a plurality of potential travel destinations based on the text string;
determining similarities between the plurality of potential travel destinations and a plurality of reference positions assigned to the user; and
ranking the plurality of potential travel destinations based on the similarities.

14. An apparatus for determining a travel destination from user generated content, the apparatus comprising:
an interface configured to receive the user generated content; and
a processor circuit configured to:
determine a text string in the user generated content that indicates a place or an address;
determine a plurality of potential travel destinations based on the text string;
determine similarities between the plurality of potential travel destinations and a plurality of reference positions assigned to the user; and
rank the plurality of potential travel destinations based on the similarities.

15. A vehicle, comprising:
an interface configured to receive user generated content;
a memory configured to store a plurality of reference positions assigned to the user; and
a processor circuit configured to:
determine a text string in the user generated content that indicates a place or an address;
determine a plurality of potential travel destinations based on the text string;
determine similarities between the plurality of potential travel destinations and the plurality of reference positions; and
rank the plurality of potential travel destinations based on the similarities.

16. The vehicle of claim 15, further comprising:
a display configured to present, to the user, one or more top-ranked potential travel destinations of the plurality of potential travel destinations; and
an input device configured to receive a user input indicating a correctness of at least one of the one or more top-ranked potential travel destinations.

17. The vehicle of claim 16, wherein, if the user input indicates one of the one or more top-ranked potential travel destinations as correct, the processor circuit is further configured to store the one of the one or more top-ranked potential travel destinations as travel destination of the user in a memory of the vehicle.

18. The vehicle of claim 15, wherein the processor circuit is configured to rank the plurality of potential travel destinations by:
determining, for each of the plurality of potential travel destinations, a maximum similarity between the respective potential travel destination and the plurality of reference positions;
selecting a subset of the plurality of potential travel destinations having a maximum similarity that is above a first threshold value; and
ranking only the subset of the plurality of potential travel destinations based on the maximum similarity.

19. The vehicle of claim 18, wherein the processor circuit is further configured to determine a quality indicator based on the number of potential travel destinations in the subset of the plurality of potential travel destinations.

20. The vehicle of claim 19, wherein the processor circuit is further configured to store the subset of the plurality of potential travel destinations together with the quality indicator in a memory of the vehicle that is accessible by software applications executed in the vehicle.
